(19) United States
(12) Patent Application Publication
(10) Pub. No.: US 2006/0171265 A1
(43) Pub. Date: Aug. 3, 2006

(54) Optical disk apparatus

(75) Inventor: Toshiaki Fukui, Daito (JP)

Correspondence Address: BACON & THOMAS, PLLC, 625 SLATERS LANE, FOURTH FLOOR, ALEXANDRIA, VA, 22314, US

(73) Assignee: FUNAI Electric Co., Ltd., Daito (JP)

(21) Appl. No.: 11/342,649

(22) Filed: Jan. 31, 2006

(30) Foreign Application Priority Data
Feb. 2, 2005 (JP) 2005-25974

(51) Int. Cl. G11B 7/00

(52) U.S. Cl. 369/44.28; 369/44.34; 369/124.01

(57) ABSTRACT

There is provided an optical disk apparatus adapted to switch the operation of an interruption detecting function and a holding function for avoiding a tracking error at an interruption between on and off efficiently in accordance with the characteristics of the optical disk and the optical pickup, whereby the stability in tracking servo can be increased. A tracking error signal is detected, and an offset value from tracking balance adjusting means 46 is applied to tracking error signal amplifying means 42 to adjust the balance of the tracking error signal so that the reference potential is positioned at the center of the tracking error signal. Interruption/holding control means 47 then determines whether or not the offset level used for the balance adjustment of the tracking error signal is equal to or greater than a threshold value, and then operates interruption detecting means 43 and holding means 44 if equal to or greater than the threshold value, while not operate the means if smaller than the threshold value.

### BACKGROUND OF THE INVENTION

1. Field of the Invention

The present invention relates to an optical disk apparatus comprising a servo control section that includes a function of detecting a tracking error signal included in an RF signal read from an optical disk and of performing tracking servo control for an optical pickup with respect to the optical disk, the apparatus being adapted to reproduce or record/reproduce information onto/from the optical disk, and more particularly to tracking servo control when an interruption is detected on an optical disk.

2. Description of the Prior Art

Conventionally, optical disk apparatuses adapted to reproduce or record/reproduce information onto/from an optical disk such as a CD (Compact Disk) or a DVD (Digital Versatile Disk) comprise a servo control section for performing focusing servo and tracking servo for an optical pickup with respect to the optical disk, and are adapted to record or record/reproduce information onto/from an optical disk while keeping a focused state and an on-track state by focusing servo and tracking servo.

In concrete terms, the control includes: applying a laser beam emitted from a laser diode in the optical pickup to the recording surface of an optical disk; processing an RF signal obtained by receiving reflected light at a light detector in the optical pickup to generate a focusing error signal and a tracking error signal; generating a focusing drive signal and a tracking drive signal as a servo signal based on these error signals to drive a focusing actuator and a tracking actuator in the optical pickup; and driving an objective lens in the optical pickup in the focusing and tracking directions.

Meanwhile, if there exists an obstruction such as a scratch and/or dust (hereinafter referred to as interruption) on a track of an optical disk, there is a possibility of a tracking error of the optical pickup. For this reason, such optical disk apparatuses have an interruption detecting function and a holding function. Interruption detecting function means a function of detecting not a large scratch with no pit but a large number of small scratches and/or dust (interruptions) with a pit on a track of an optical disk whereby a tracking error signal cannot be detected normally by determining the amplitude level of an RF signal. Also, holding function means a function of holding the last tracking drive signal when an interruption is detected.

Therefore, if there exists an interruption on an optical disk, conventional optical disk apparatuses are adapted to: detect the interruption by an interruption detecting function; hold the last tracking drive signal when the interruption is detected by a holding function; and perform tracking control for the optical pickup with respect to the optical disk using thus held tracking drive signal.

However, in optical disk apparatuses that employ a tracking balance correction system for correcting a tracking error signal that indicates a large tracking balance disruption by offset, only an offset value is to be left at a point where a tracking error signal cannot be detected normally due to an interruption on an optical disk (refer to Fig.4 (3)), resulting in a problem of a tracking error. For this reason, it is tried to: detect an interruption by an interruption detecting function; hold a tracking drive signal immediately before the interruption detection by a holding function; and drive the tracking actuator in the optical pickup using thus held tracking drive signal to avoid a tracking error. However, even if the balance of a tracking error signal is not disrupted, both the interruption detecting function and the holding function operate when running into an interruption, that is, at an unnecessary point, resulting rather in a possibility of stability loss in tracking servo.

It is noted that the prior art described in Japanese Patent Laid-Open Publication No. 2003-168227 is adapted to hold a tracking drive signal (tracking servo signal) at a point on an optical disk where a scratch and/or dust make it impossible to detect a tracking error signal normally regardless of the balance of the tracking error signal, which cannot solve the above-described problems. Also, the prior art described in Japanese Patent Laid-Open Publication No. Sho 62-46441 is adapted to correct the difference between the center of a tracking error signal (tracking signal) and that of an original track using a correction value (offset), not relating to tracking correction at a point where a tracking error signal cannot be detected normally, which also cannot solve the above-described problems.

### SUMMARY OF THE INVENTION

The present invention has been made to solve the above-described problems, and an object thereof is to provide an optical disk apparatus adapted to switch the operation of an interruption detecting function and a holding function for avoiding a tracking error at an interruption on an optical disk between on and off efficiently in accordance with the characteristics of the optical disk and the optical pickup, whereby the stability in tracking servo can be increased.

In order to achieve the foregoing object, the invention according to claim 1 provides an optical disk apparatus wherein a servo control section comprises: tracking error signal detecting means for detecting a tracking error signal; tracking error signal amplifying means for amplifying the detected tracking error signal; tracking drive means for generating a tracking drive signal for driving a tracking actuator in an optical pickup based on the amplified tracking error signal; interruption detecting means for detecting an interruption on an optical disk by monitoring the amplitude level of an RF signal; holding means for receiving and holding the last tracking drive signal when the interruption is detected from the tracking drive means; tracking balance adjusting means for adjusting the balance of the tracking error signal by inputting an offset value into the tracking error signal amplifying means; and interruption/holding control means for determining whether or not the offset value as an adjustment value for balance adjustment is equal to or greater than a predefined threshold value and for operating the interruption detecting means and the holding means if equal to or greater than the threshold value, while not operating the interruption detecting means and the holding means if smaller than the threshold value.

In the arrangement above, when the optical disk is spun up, a tracking error signal included in an RF signal read from the optical disk is to be detected by the tracking error signal detecting means to be amplified in the tracking error signal amplifying means, and then input into the tracking drive means to generate a tracking drive signal. The tracking drive signal is then to be fed to the tracking actuator to perform tracking servo control.

Also, when the optical disk is spun up, an offset value from the tracking balance adjusting means is to be applied to the tracking error signal amplifying means to adjust the balance of the tracking error signal so that the reference potential for the tracking error signal is positioned at the center of the tracking error signal. The interruption/holding control means then determines whether or not the balance adjustment value (offset level) used for the balance adjustment of the tracking error signal is equal to or greater than a threshold value, and then operates the interruption detecting means and the holding means if equal to or greater than the threshold value, while not operate the interruption detecting means and the holding means if smaller than the threshold value.

In accordance with the above arrangement, if the balance adjustment value used for the balance adjustment of the tracking error signal is equal to or greater than the threshold value, the interruption detecting means and the holding means are to be operated, while if neither an interruption detecting function nor a holding function is required in accordance with the characteristics of the optical disk and the optical pickup, etc., the balance adjustment value becomes smaller than the threshold value not to operate the interruption detecting means and the holding means, which allows for stabilized tracking servo without holding an unnecessary tracking drive signal.

The invention according to claim 2 provides an optical disk apparatus wherein a servo control section comprises: interruption detecting means for detecting an interruption on an optical disk by monitoring the amplitude level of an RF signal; holding means for holding the last tracking drive signal when the interruption is detected; and interruption/holding control means for operating the interruption detecting means and the holding means only if an offset value for adjusting the balance of a tracking error signal is so large that there is a possibility of causing a trouble at the interruption.

In the arrangement above, the interruption detecting means and the holding means are to be operated only if an offset value for adjusting the balance of a tracking error signal is so large that there is a possibility of causing a trouble at the interruption. Therefore, in accordance with this arrangement, if neither an interruption detecting function nor a holding function is required in accordance with the characteristics of the optical disk and the optical pickup, etc., the interruption detecting means and the holding means are not to be operated, which allows for stabilized tracking servo without holding an unnecessary tracking drive signal.

In the invention according to claim 3, the invention according to claim 2 is arranged in such a manner that the interruption/holding control means is adapted to determine whether or not the offset value as a balance adjustment value for adjusting the balance of the tracking error signal is equal to or greater than a predefined threshold value and to operate the interruption detecting means and the holding means if equal to or greater than the threshold value, while not to operate the interruption detecting means and the holding means if smaller than the threshold value, whereby if neither an interruption detecting function nor a holding function is required in accordance with the characteristics of the optical disk and the optical pickup, etc., the interruption detecting means and the holding means are not to be operated.

In the invention according to claim 4, the invention according to claim 2 is arranged in such a manner that the servo control section further comprises: tracking error signal detecting means for detecting the tracking error signal; tracking error signal amplifying means for amplifying the detected tracking error signal; tracking drive means for generating a tracking drive signal for driving a tracking actuator in the optical pickup based on the amplified tracking error signal; and tracking balance adjusting means for adjusting the balance of the tracking error signal by inputting an offset value into the tracking error signal amplifying means, and that the interruption/holding control means is adapted to determine whether or not the offset value as an adjustment value for balance adjustment is equal to or greater than a predefined threshold value and to operate the interruption detecting means and the holding means if equal to or greater than the threshold value, while not to operate the interruption detecting means and the holding means if smaller than the threshold value.

Therefore, if the balance adjustment value (offset level) used for the balance adjustment of the tracking error signal is equal to or greater than the threshold value, it is possible to achieve a specific arrangement for operating the interruption detecting means and the holding means, while if neither an interruption detecting function nor a holding function is required in accordance with the characteristics of the optical disk and the optical pickup, etc., the interruption detecting means and the holding means are not to be operated.

As described heretofore, in accordance with the present invention, a servo control section comprises: tracking error signal detecting means for detecting a tracking error signal; tracking error signal amplifying means for amplifying the detected tracking error signal; tracking drive means for generating a tracking drive signal for driving a tracking actuator in an optical pickup based on the amplified tracking error signal; interruption detecting means for detecting an interruption on an optical disk by monitoring the amplitude level of an RF signal; holding means for receiving and holding the last tracking drive signal when the interruption is detected from the tracking drive means; tracking balance adjusting means for adjusting the balance of the tracking error signal by inputting an offset value into the tracking error signal amplifying means; and interruption/holding control means for determining whether or not the offset value as an adjustment value for balance adjustment is equal to or greater than a predefined threshold value and for operating the interruption detecting means and the holding means if equal to or greater than the threshold value, while not operating the interruption detecting means and the holding means if smaller than the threshold value, whereby if neither an interruption detecting function nor a holding function is required in accordance with the characteristics of the optical disk and the optical pickup, etc., the interruption detecting means and the holding means are not to be operated, which allows for stabilized tracking servo without holding an unnecessary tracking drive signal.

Also, in accordance with the present invention, a servo control section comprises: interruption detecting means for detecting an interruption on an optical disk by monitoring the amplitude level of an RF signal; holding means for holding the last tracking drive signal when the interruption is detected; and interruption/holding control means for operating the interruption detecting means and the holding means only if an offset value for adjusting the balance of a tracking error signal is so large that there is a possibility of causing a trouble at the interruption, whereby if neither an interruption detecting function nor a holding function is required in accordance with the characteristics of the optical disk and the optical pickup, etc., the interruption detecting means and the holding means are not to be operated, which allows for stabilized tracking servo without holding an unnecessary tracking drive signal.

### BRIEF DESCRIPTION OF THE DRAWINGS

FIG. 1 is a block diagram showing the configuration of an optical disk apparatus according to an embodiment of the present invention;

FIG. 2 is a block diagram illustrating the arrangement for tracking servo in the servo control section shown in FIG. 1;

FIG. 3 is a signal waveform diagram for illustrating an interruption detection signal and a tracking drive signal in the embodiment;

FIG. 4 is a signal waveform diagram for illustrating a tracking error signal in the embodiment; and

FIG. 5 is a flow chart for illustrating a control process for turning an interruption detecting function and a holding function on and off in the embodiment.

### DESCRIPTION OF THE PREFERRED EMBODIMENTS

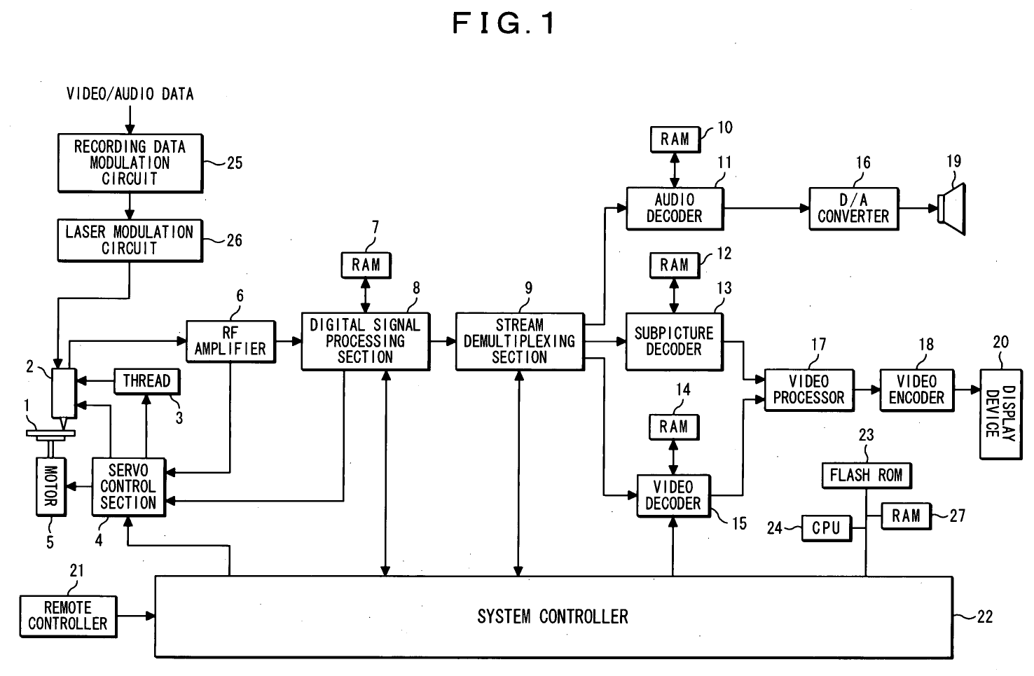

An embodiment of the present invention will hereinafter be described with reference to the accompanying drawings. FIG. 1 is a block diagram showing the configuration of an optical disk apparatus according to an embodiment of the present invention. Although here will be described the configuration of an optical disk apparatus such as a DVD recorder, it will be appreciated that the control process for turning the operation of an interruption detecting function and a holding function on and off can also be applied to an optical disk apparatus such as a DVD player.

The optical disk apparatus comprises: a spindle motor 5 for rotating an optical disk 1; an optical pickup 2 for emitting a laser beam to record/reproduce information onto/from the optical disk 1 and for receiving reflected light from the optical disk 1; a thread 3 for moving the optical pickup 2 in the radial direction of the optical disk 1; and a servo control section 4 for driving the spindle motor 5 and the thread 3 in accordance with an instruction from a system controller 22 and for moving an objective lens (not shown in the figure) built in the optical pickup 2 to move the focus position of the laser beam vertically and horizontally with respect to the recording surface of the optical disk 1.

The optical disk apparatus also comprises: an RF amplifier 6 for amplifying an RF signal as a readout signal from the optical pickup 2 when reproducing the optical disk 1; a digital signal processing section 8 for performing signal demodulation processing and ECC error correction processing in accordance with the data format of the optical disk 1 after converting an RF signal output from the RF amplifier 6 into digital data and then storing the generated data in a RAM 7; and a stream demultiplexing section 9 for demultiplexing data stream output from the digital signal processing section 8 in accordance with an instruction from the system controller 22 into audio data, subpicture data, and video data.

The optical disk apparatus further comprises: an audio decoder 11 for receiving audio data output from the stream demultiplexing section 9 to perform predetermined decode processing; a RAM 10 for temporarily storing data to be subject to the decode processing in the audio decoder 11; a subpicture decoder 13 for receiving subpicture data output from the stream demultiplexing section 9 to perform predetermined decode processing; a RAM 12 for temporarily storing data to be subject to the decode processing in the subpicture decoder 13; a video decoder 15 for receiving video data output from the stream demultiplexing section 9 to perform predetermined decode processing; and a RAM 14 for temporarily storing data to be subject to the decode processing in the video decoder 15.

The optical disk apparatus still further comprises: a video processor 17 for synthesizing data output from the video decoder 15 and data output from the subpicture decoder 13 in accordance with an instruction from the system controller 22; a video encoder 18 for converting synthesized data output from the video processor 17 into a video signal for display to display an image on a display device 20; and a D/A converter 16 for converting data output from the audio decoder 11 into an analog audio signal to be fed to, for example, a speaker 19.

The optical disk apparatus also comprises: a remote controller 21 having various kinds of operation keys such as a reproduction key for instructing the system controller 22 to start reproduction using an infrared signal, a stop key for instructing to stop reproduction, a record key for instructing to start recording, and a power key; and the system controller 22 for controlling the entire apparatus.

Further, the optical disk apparatus comprises: a flash ROM 23 with programs and data for controlling the components in the apparatus and the entire apparatus stored therein; a CPU 24 for performing arithmetic processing based on the programs and data in the flash ROM 23 to control the system controller 22; and a RAM 27 for temporarily storing data required for the processing in the CPU 24.

Furthermore, the optical disk apparatus comprises: a recording data modulation circuit 25 for modulating video/audio data sent from a TV receiver or a personal computer, etc. (not shown in the figure) to be recorded on the optical disk 1; and a laser modulation circuit 26 for outputting a laser modulation signal, which is adapted to modulate a laser beam to be emitted from the optical pickup 2 based on modulation data modulated by the recording data modulation circuit 25, to the optical pickup 2.

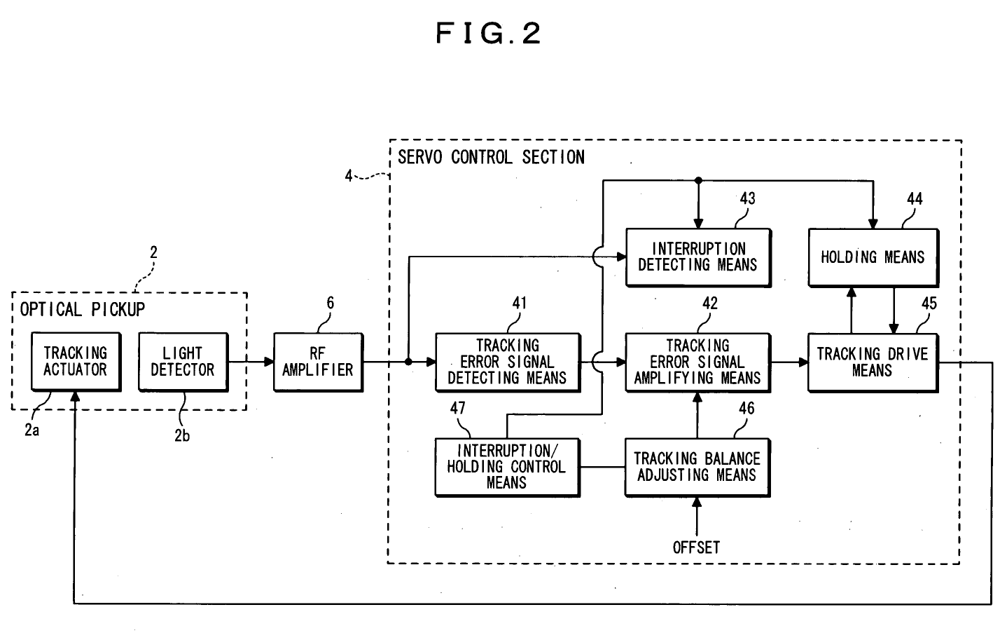

FIG. 2 is a block diagram illustrating the arrangement for tracking servo in the servo control section 4 shown in FIG. 1. In FIG. 2, the servo control section 4 comprises: tracking error signal detecting means 41 for detecting a tracking error signal included in an RF signal from the RF amplifier 6; tracking error signal amplifying means 42 for amplifying the detected tracking error signal; and tracking drive means 45 for generating a tracking drive signal for driving a tracking actuator 2a in the optical pickup 2 based on the amplified tracking error signal.

The servo control section 4 also comprises: interruption detecting means 43 for detecting an interruption on the optical disk 1 by monitoring the amplitude level of the RF signal from the RF amplifier 6; and holding means 44 for receiving and holding the last tracking drive signal when the interruption is detected from the tracking drive means 45; tracking balance adjusting means 46 for adjusting the balance of the tracking error signal by inputting an offset value into the tracking error signal amplifying means 42; and interruption/holding control means 47 for determining whether or not the offset value as an adjustment value for balance adjustment is equal to or greater than a predefined threshold value and for operating the interruption detecting means 43 and the holding means 44 if equal to or greater than the threshold value, while not operating the interruption detecting means 43 and the holding means 44 if smaller than the threshold value.

The light detector 2b in the optical pickup 2 has four divided light receiving elements (not shown in the figure), where assuming that output signals from the four divided light receiving elements are represented, respectively, by A, B, C, and D, the signal obtained by shaping the waveform of the signal (A+B+C+D) represents a reproduced RF signal, and the differential signal (A+C)-(B+D) obtained by dividing the four divided light receiving elements into two light receiving element groups in the circumferential direction of the optical disk represents a focusing error signal, while the differential signal (A+D)-(B+C) obtained by dividing the four divided light receiving elements into two light receiving element groups in the radial direction of the optical disk represents a tracking error signal. Therefore, the RF amplifier 6 is adapted to output an RF signal obtained by shaping the waveform of a signal (A+B+C+D), and the tracking error signal detecting means 41 in the servo control section 4 is adapted to detect a tracking error signal (A+D)-(B+C) from the RF signal.

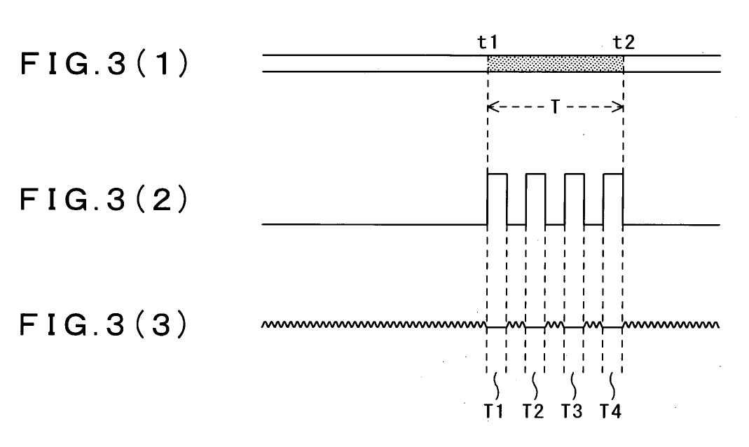

FIG. 3 is a signal waveform diagram for illustrating an interruption detection signal and a tracking drive signal in the present embodiment. FIG. 3 (1) shows a certain track on an optical disk, indicating that there exists an interruption within a time period T from the time t1 to t2 on the track. FIG. 3 (2) shows an interruption detection signal detected by the interruption detecting means 43. FIG. 3 (3) shows a tracking drive signal output from the tracking drive means 45, where tracking servo is to be turned off within time periods T1, T2, T3, and T4 in the tracking drive signal and the tracking actuator 2a in the optical pickup 2 is to be driven by a tracking drive signal immediately before running into the interruption.

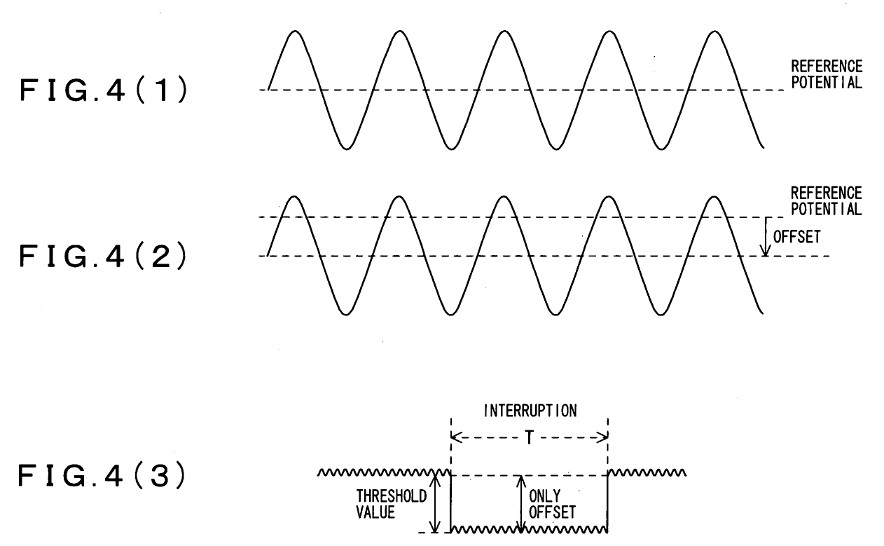

FIG. 4 is a signal waveform diagram for illustrating a tracking error signal in the present embodiment. FIG. 4 (1) shows a tracking error signal output from the tracking error signal detecting means 41 with tracking servo off. In this case, the reference potential is positioned at the center of the tracking error signal, where tracking servo control is to be performed using the reference potential.

FIG. 4 (2) also shows a tracking error signal, where the reference potential is shifted upward from the center of the tracking error signal. If the reference potential is thus shifted, a tracking error is likely to occur. Therefore, since it is necessary to position the reference potential at the center of the tracking error signal, an offset value is applied to the tracking error signal to position the reference potential relatively at the center of the tracking error signal

FIG. 4 (3) shows a state of a tracking error signal when a laser beam emitted from the optical pickup 2 runs into an interruption on an optical disk, where an offset value only appears within the time period T of the interruption not to output a normal tracking error signal. Thus, the balance of the tracking error signal is to be disrupted at the moment the time period T of the interruption has passed, which may accordingly cause a tracking error and thereby a trouble.

Hence, in order to prevent such a trouble, the holding means 44 is used in the servo control section 4 as mentioned above to hold a tracking drive signal immediately before running into an interruption and then to drive the tracking actuator 2a in the optical pickup 2 using the tracking drive signal so that a laser beam emitted from the optical pickup 2 can be applied to the center of a target track on the optical disk 1.

The offset level (offset value), which is to be determined based on a detected state that represents how far the center of a tracking error signal is separated from the reference potential when the optical disk 1 is spun up, depends on the characteristics of the optical disk and the optical pickup, etc. If the offset level is equal to or greater than a threshold value, a tracking drive signal immediately before running into an interruption is held and thus held tracking drive signal is to be used in the time period of the interruption, or there may occur a tracking error. Therefore, the tracking drive signal is to be held by the holding means 44. It is noted that the threshold value is preliminarily set to an offset level at which there may occur a trouble at an interruption.

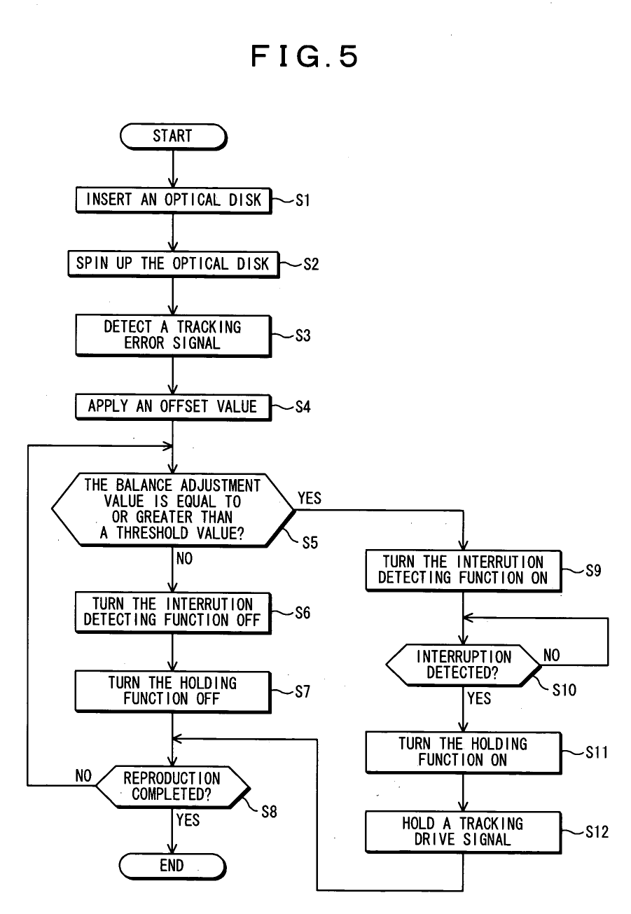

FIG. 5 is a flow chart for illustrating a control process for turning an interruption detecting function and a holding function on and off in the present embodiment. A control process for turning an interruption detecting function and a holding function on and off will be described with reference to this flow chart.

An optical disk 1 is inserted into the optical disk apparatus (step S1), and then spun up (step S2). That is, after inserting the optical disk 1 into the optical disk apparatus, the optical disk 1 is rotated and recorded information is read from the optical disk 1 by the optical pickup 2. Then, an RF signal is output from the light detector 2b in the optical pickup 2 (refer to FIG. 2) to be amplified in the RF amplifier 6 to be input into the servo control section 4.

In the servo control section 4, a tracking error signal included in the input RF signal is detected by the tracking error signal detecting means 41, and then the tracking error signal is amplified in the tracking error signal amplifying means 42 to be input into the tracking drive means 45. Thus, a tracking drive signal is generated and fed to the tracking actuator 2a in the optical pickup 2 to drive the tracking actuator 2a and thereby to perform tracking servo control. Meanwhile, a focusing error signal included in the input RF signal is detected by focusing error signal detecting means (not shown in the figure), and then the focusing error signal is input into focusing drive means (not shown in the figure) through focusing error signal amplifying means (not shown in the figure). Thus, a focusing drive signal is generated and fed to a focusing actuator (not shown in the figure) in the optical pickup 2 to drive the focusing actuator and thereby to perform focusing servo control.

After the optical disk 1 is spun up (step S2), the tracking error signal included in the RF signal from the RF amplifier 6 is detected by the tracking error signal detecting means 41 (step S3), and then amplified in the tracking error signal amplifying means 42. Then, an offset value from the tracking balance adjusting means 46 is applied to the tracking error signal amplifying means 42 (step S4) to adjust the balance of the tracking error signal so that the reference potential for the tracking error signal is positioned at the center of the tracking error signal.

Subsequently, the interruption/holding control means 47 determines whether or not the balance adjustment value (offset level) used for the balance adjustment of the tracking error signal is equal to or greater than a threshold value (step S5), and then turns the interruption detecting means 43 on so as to operate if equal to or greater than the threshold value (step S9). Then, if an interruption is detected on the optical disk 1 (step S10), the holding means 44 is turned on so as to operate (step S11). Thus, the holding means 44 receives and holds the last tracking drive signal when the interruption is detected from the tracking drive means 45 (step S12). Then, if the reproduction has not yet been completed (step S8), the routine is returned to the processing in step S5.

Meanwhile, if the interruption/holding control means 47 determines that the balance adjustment value of the tracking error signal is smaller than the threshold value (step S5), the interruption/holding control means 47 turns the interruption detecting means 43 off so as not to operate (step S6), and also turns the holding means 44 off so as not to operate (step S7). Then, if the reproduction has not yet been completed (step S8), the routine is returned to the processing in step S5.

As described heretofore, in accordance with the present embodiment, if the balance adjustment value used for the balance adjustment of the tracking error signal is equal to or greater than the threshold value, the interruption detecting means and the holding means are to be operated, while if neither an interruption detecting function nor a holding function is required in accordance with the characteristics of the optical disk and the optical pickup, etc., the balance adjustment value becomes smaller than the threshold value not to operate the interruption detecting means and the holding means, which allows for stabilized tracking servo without holding an unnecessary tracking drive signal.

What is claimed is:

1. An optical disk apparatus comprising a servo control section that includes a function of detecting a tracking error signal included in an RF signal read from an optical disk and of performing tracking servo control for an optical pickup with respect to said optical disk, said apparatus being adapted to reproduce or record/reproduce information onto/from said optical disk, wherein
said servo control section comprises:
tracking error signal detecting means for detecting said tracking error signal;
tracking error signal amplifying means for amplifying said detected tracking error signal;
tracking drive means for generating a tracking drive signal for driving a tracking actuator in said optical pickup based on said amplified tracking error signal;
interruption detecting means for detecting an interruption on said optical disk by monitoring the amplitude level of said RF signal;
holding means for receiving and holding the last tracking drive signal when said interruption is detected from said tracking drive means;
tracking balance adjusting means for adjusting the balance of said tracking error signal by inputting an offset value into said tracking error signal amplifying means; and
interruption/holding control means for determining whether or not said offset value as an adjustment value for balance adjustment is equal to or greater than a predefined threshold value and for operating said interruption detecting means and said holding means if equal to or greater than said threshold value, while not operating said interruption detecting means and said holding means if smaller than said threshold value.

2. An optical disk apparatus comprising a servo control section that includes a function of detecting a tracking error signal included in an RF signal read from an optical disk and of performing tracking servo control for an optical pickup with respect to said optical disk, said apparatus being adapted to reproduce or record/reproduce information onto/from said optical disk, wherein
said servo control section comprises:
interruption detecting means for detecting an interruption on said optical disk by monitoring the amplitude level of said RF signal;
holding means for holding the last tracking drive signal when said interruption is detected; and
interruption/holding control means for operating said interruption detecting means and said holding means only if an offset value for adjusting the balance of said tracking error signal is so large that there is a possibility of causing a trouble at said interruption.

3. The optical disk apparatus according to claim 2, wherein said interruption/holding control means is adapted to determine whether or not said offset value as a tracking balance adjustment value for adjusting the balance of said tracking error signal is equal to or greater than a predefined threshold value and to operate said interruption detecting means and said holding means if equal to or greater than said threshold value, while not to operate said interruption detecting means and said holding means if smaller than said threshold value.

4. The optical disk apparatus according to claim 2, wherein
said servo control section further comprises:
tracking error signal detecting means for detecting said tracking error signal;
tracking error signal amplifying means for amplifying said detected tracking error signal;
tracking drive means for generating a tracking drive signal for driving a tracking actuator in said optical pickup based on said amplified tracking error signal; and
tracking balance adjusting means for adjusting the balance of said tracking error signal by inputting an offset value into said tracking error signal amplifying means, and wherein
said interruption/holding control means is adapted to determine whether or not said offset value as an adjustment value for balance adjustment is equal to or greater than a predefined threshold value and to operate said interruption detecting means and said holding means if equal to or greater than said threshold value, while not to operate said interruption detecting means and said holding means if smaller than said threshold value.
